(19) United States
(12) Patent Application Publication
(10) Pub. No.: US 2025/0373140 A1
(43) Pub. Date: Dec. 4, 2025

(54) DC-DC CONVERTER AND CORRESPONDING METHOD OF OPERATION

(71) Applicant: STMicroelectronics International N.V., Geneva (CH)

(72) Inventors: Alessandro BERTOLINI, Vermiglio (IT); Osvaldo Enrico ZAMBETTI, Milano (IT); Alessandro GASPARINI, Cusano Milanino (IT); Simone ZAFFIN, Cairate, Varese (IT); Salvatore LEVANTINO, Milano (IT); Massimo GHIONI, Monza, MB (IT)

(73) Assignee: STMicroelectronics International N.V., Geneva (CH)

(21) Appl. No.: 19/214,205

(22) Filed: May 21, 2025

(30) Foreign Application Priority Data
May 30, 2024 (IT) 102024000012382

(51) Int. Cl. H02M 1/00; H02M 3/155

(52) U.S. Cl. CPC H02M 1/0048; H02M 3/155

(57) ABSTRACT

A hybrid DC-DC converter includes a first capacitor coupled between first and second nodes, a second capacitor coupled between third and fourth nodes, and a third capacitor coupled between fifth and sixth nodes. An inductor is coupled between the second node and an output. Each switching cycle of the converter includes a first phase where the first node is coupled to an input, the second and third nodes are coupled to each other, the fourth node is coupled to ground, the fifth node is coupled to the output, and the sixth node is coupled to ground. The switching cycle further includes a last phase where the first, fourth and fifth nodes are coupled to each other, the second node is coupled to ground, the third node is coupled to the input, and the sixth node is coupled to the output.

### PRIORITY CLAIM

This application claims the priority benefit of Italian Application for U.S. Pat. No. 10,202,4000012382 filed on May 30, 2024, the content of which is hereby incorporated by reference in its entirety to the maximum extent allowable by law.

### TECHNICAL FIELD

The description relates to DC-DC converters, in particular to hybrid DC-DC converters that combine switched-capacitor-based and inductor-based topologies.

Such DC-DC converters may be applied, for instance, to integrated circuits for battery chargers, power management integrated circuits (PMIC), data storage DC-DC, point-of-load converters.

### BACKGROUND

The core voltage of today's CMOS technology is typically lower than 1 V, and there is an increasing interest for DC-DC converters that carry out a conversion from a higher supply voltage (e.g., 5 V) to the core voltage. For instance, such DC-DC converters may be applied to highly dense digital cores, such as central processing units (CPU), graphic processing units (GPU) and digital signals processors (DSP).

At high conversion ratios, inductor-based DC-DC converters may not be suitable for achieving high power densities as the inductor remains the largest component. In addition, large device voltage stress (relative to the output voltage) limits the conversion efficiency. Switched capacitors (SC) and resonant converters, on the other hand, may provide high power densities but may be affected by poor efficiency under output voltage regulation. In this respect, reference is made to Schaef, et al., “A 3-Phase Resonant Switched Capacitor Converter Delivering 7.7 W at 85% Efficiency Using 1.1 nH PCB Trace Inductors,” in IEEE Journal of Solid-State Circuits, vol. 50, no. 12, pp. 2861-2869, doi: 10.1109/JSSC.2015.2462351 and Li, et al., “AC-Coupled Stacked Dual-Active-Bridge DC-DC Converter for Integrated Lithium-Ion Battery Power Delivery,” in IEEE Journal of Solid-State Circuits, vol. 54, no. 3, pp. 733-744, doi: 10.1109/JSSC.2018.2883746 (both incorporated herein by reference) as being exemplary of the prior art.

Hybrid DC-DC converters, which rely on the combination of a small inductance for output voltage regulation and capacitors to increase the power density, provide the advantages of traditional topologies and are well suited for applications involving high conversion ratios, as they achieve high efficiency, high power density and output voltage regulation. In fact, in a hybrid DC-DC converter the inductor current ripple ΔI_{L} directly depends on the voltage drop ΔV_{L} across the terminals of the inductor itself, as indicated by the following equation where L is the inductance of the inductor and F_{SW} is the switching frequency of the DC-DC converter:

$$Δ {I}_{L} = \frac{Δ {V}_{L}}{L \cdot {F}_{SW}}$$

Hybrid DC-DC converters rely on the presence of capacitors to scale down the converter input voltage, so that the voltage drop ΔV_{L} across the inductor terminals is reduced. Therefore, targeting the same current ripple ΔI_{L} and using the same converter switching frequency F_{SW}, the inductance L of a hybrid DC-DC converter can be reduced significantly with respect to the inductance of a buck DC-DC converter that carries out the same voltage conversion. Since the inductor is the component of DC-DC converters that occupies most of the area, also the total footprint of a hybrid DC-DC converter can be reduced significantly with respect to the footprint of a buck DC-DC converter, even considering the presence of the additional capacitors (insofar as capacitors provide a much larger power density than inductors, e.g., they can be up to 100 times more power-dense than inductors).

In a conventional implementation of a hybrid DC-DC converter, the inductor may be arranged right before the output capacitor. Reference is made to Liu, et al., “10.3 A 94.2%-peak-efficiency 1.53 A direct-battery-hook-up hybrid Dickson switched-capacitor DC-DC converter with wide continuous conversion ratio in 65 nm CMOS,” in 2017 IEEE International Solid-State Circuits Conference (ISSCC), doi: 10.1109/ISSCC.2017.7870321 (incorporated herein by reference) as exemplifying such a conventional implementation. In this configuration, the performance of the converter is still ultimately limited by the fact that the discrete inductor carries a DC current equal to the load current. In addition to that, a sophisticated control strategy (e.g., including more than two phases) is needed to regulate the output voltage.

Reference is also made to Cai, et al., “A Battery-Input Sub-1V Output 92.9% Peak Efficiency 0.3 A/mm² Current Density Hybrid SC-Parallel-Inductor Buck Converter with Reduced Inductor Current in 65 nm CMOS,” in 2022 IEEE International Solid-State Circuits Conference (ISSCC), doi: 10.1109/ISSCC42614.2022.9731576 (incorporated herein by reference) as disclosing another topology of a hybrid DC-DC converter, which combines the structure of a switched-capacitor converter with a buck converter. FIG. 1 is a circuit diagram exemplary of such known converter topology. Substantially, the hybrid DC-DC converter 10 of FIG. 1 has an input terminal 102 configured to receive an input voltage VIN and an output terminal 104 configured to produce an output voltage V_{OUT}. A switching circuit (e.g., two transistors connected in series) is arranged between the input terminal 102 and a node 106, and is controlled by a control signal S₁. Node 106 is at voltage V_{F1}. A capacitor C_{F1} is arranged between node 106 and a node 108. Node 108 is at voltage V_{F2}. A switching circuit (e.g., two transistors connected in series) is arranged between node 108 and ground GND, and is controlled by a control signal S₂. An electronic switch is arranged between the output terminal 104 and a node 114, and is controlled by a control signal S₅. Node 114 is at voltage V_{F3}. An electronic switch is arranged between the output terminal 104 and a node 116, and is controlled by a control signal S₆. Node 116 is at voltage V_{F4}. An electronic switch is arranged between node 116 and ground GND, and is controlled by a control signal S₄. A capacitor C_{F2} is arranged between node 114 and node 116. A switching circuit (e.g., two transistors connected in series) is arranged between node 106 and node 114, and is controlled by a control signal S₃. An inductor L (e.g., discrete, external) is arranged between node 108 and the output terminal 104. An output capacitor C_{OUT} (e.g., an external capacitor) may be arranged between the output terminal 104 and ground GND. The DC-DC converter provides an output current I_{OUT}. The DC-DC converter 10 of FIG. 1 is operated according to a two-phase control strategy, wherein the two control phases are complementary. Specifically, in the first control phase signals S₁, S₄ and S₅ are asserted while signals S₂, S₃ and S₆ are de-asserted, and in the second control phase signals S₁, S₄ and S₅ are de-asserted while signals S₂, S₃ and S₆ are asserted.

The DC current I_{L,DC} flowing through the inductor L can be computed by the following equation, where I_{LOAD} is the load current and D is the duty-cycle:

$${I}_{L , DC} = \frac{{I}_{LOAD}}{1 + 2 D}$$

With the converter topology exemplified in FIG. 1, the inductor L can be downsized also by reducing the magnetic core dimensions. Moreover, the converter efficiency does not depend directly on the DC resistance (DC_{R}) of the inductor L. The peculiar arrangement of the inductor L allows to regulate the output voltage V_{OUT} via a simple modulation of the duty-cycle, as indicated by the following equation:

$${V}_{OUT} = \frac{{V}_{IN} \cdot D}{1 + 2 D}$$

However, the converter topology exemplified in FIG. 1 does not result in quasi-DC input current, meaning that the input filter capacitance must be large and has a large root mean square (rms) current, and that a high voltage-rated power MOS transistor has to handle the whole inductor current. Moreover, the converter topology exemplified in FIG. 1 suffers from high charge redistribution losses: the charging/discharging current of the capacitor C_{F2} and the discharging current of the capacitor C_{F1} in the second phase are not limited by any inductive element. They rather have an exponential shape, with a decay time set by the capacitance of the capacitors and the on-resistance values of the power MOS transistors. This could lead to high rms currents and therefore increased losses.

Therefore, there is a need in the art to provide improved hybrid DC-DC converters, which mitigate one or more of the drawbacks mentioned above.

### SUMMARY

One or more embodiments may relate to a DC-DC converter.

One or more embodiments may relate to a corresponding method of operating a DC-DC converter.

According to an aspect of the present description, a DC-DC converter includes an input terminal configured to receive an input voltage, and an output terminal configured to produce an output voltage. A first capacitor is coupled between a first node and a second node, a second capacitor is coupled between a third node and a fourth node, and a third capacitor is coupled between a fifth node and a sixth node. The second node and the output terminal are configured for coupling to the first terminal and the second terminal, respectively, of an inductor. A switching circuitry is controllable to: selectively coupling the first node to one or more of the input terminal and the fifth node; selectively coupling the second node to one or more of the third node and ground; selectively coupling the third node to one or more of the input terminal and the second node; selectively coupling the fourth node to one or more of the fifth node and ground; selectively coupling the fifth node to one or more of the first node, the fourth node and the output terminal; and selectively coupling the sixth node to one or more of the output terminal and ground. A control circuit is configured to produce one or more control signals for the switching circuitry. During a switching cycle of the DC-DC converter the control circuit controls the switching circuitry in at least a first phase and a last phase. During the first phase, the first node is coupled to the input terminal, the second node and the third node are coupled to each other, the fourth node is coupled to ground, the fifth node is coupled to the output terminal, and the sixth node is coupled to ground. During the last phase, the first node and the fourth node and the fifth node are coupled to each other, the second node is coupled to ground, the third node is coupled to the input terminal, and the sixth node is coupled to the output terminal.

It will be noted that the wording “selectively coupling a node to one or more of . . . ” as used herein means that the concerned node can be coupled to another node, a plurality or other nodes, or to none of the other nodes (e.g., left floating).

One or more embodiments may thus provide an interleaved hybrid DC-DC converter with quasi-DC input current, where the current carried by the high voltage-rated MOS transistors is halved with respect to prior solutions, where the inductor can be downsized with respect to prior solutions, and where regulation of the output voltage is obtained via a simple duty-cycle modulation.

Optionally, the DC-DC converter may include a resonant inductor arranged in series to the third capacitor between the fifth node and the sixth node.

Optionally, during a switching cycle of the DC-DC converter the control circuit controls the switching circuitry in at least an intermediate phase that follows the first phase, and a further intermediate phase that follows the intermediate phase. During the intermediate phase, the first node is floating, the second node is coupled to ground, the third node is floating, the fourth node is coupled to ground, the fifth node is coupled to the output terminal, and the sixth node is coupled to ground. During the further intermediate phase, the first node is floating, the second node is coupled to ground, the third node is coupled to the input terminal, the fourth node is floating, the fifth node is floating, and the sixth node is floating.

Optionally, during a switching cycle of the DC-DC converter the control circuit controls the switching circuitry in at least an intermediate phase that follows the first phase, and a further intermediate phase that follows the intermediate phase. During the intermediate phase, the first node is coupled to the input terminal, the second node and the third node are coupled to each other, the fourth node is coupled to ground, the fifth node is coupled to the output terminal, and the sixth node is floating. During the further intermediate phase, the first node is floating, the second node is coupled to ground, the third node is coupled to the input terminal, the fourth node is floating, the fifth node is floating, and the sixth node is floating.

Optionally, during a switching cycle of the DC-DC converter the control circuit controls the switching circuitry in at least an intermediate phase that follows the first phase. During the intermediate phase, the first node is coupled to the input terminal, the second node and the third node are coupled to each other, the fourth node is coupled to ground, the fifth node is coupled to the output terminal, and the sixth node is floating.

Optionally, the resonant inductor has an inductance of about 1 nH.

Optionally, the resonant inductor is implemented by parasitic inductance of vias and/or metal traces.

Optionally, the switching circuitry includes transistors, optionally metal-oxide-semiconductor transistors, optionally n-channel metal-oxide-semiconductor transistors.

According to another aspect of the present description, a method of operating a DC-DC converter includes: coupling the first terminal and the second terminal of an inductor to the second node of the DC-DC converter and the output terminal of the DC-DC converter, respectively; receiving an input voltage at the input terminal; producing one or more control signals for the switching circuitry so that, during a switching cycle of the DC-DC converter, the switching circuitry is controlled in at least: a first phase, during which the first node is coupled to the input terminal, the second node and the third node are coupled to each other, the fourth node is coupled to ground, the fifth node is coupled to the output terminal, and the sixth node is coupled to ground; and a last phase, during which the first node and the fourth node and the fifth node are coupled to each other, the second node is coupled to ground, the third node is coupled to the input terminal, and the sixth node is coupled to the output terminal, producing an output voltage at the output terminal.

### BRIEF DESCRIPTION OF THE DRAWINGS

One or more embodiments will now be described, by way of example only, with reference to the annexed figures, wherein:

FIG. 1, previously presented, is a circuit diagram exemplary of a hybrid DC-DC converter according to the prior art;

FIG. 2 is a circuit diagram exemplary of a hybrid DC-DC converter according to one or more embodiments;

FIGS. 3A and 3B are two circuit diagrams exemplary of the topology of the reactive components of the DC-DC converter of FIG. 2 during two different control phases;

FIG. 4 is a circuit diagram exemplary of another hybrid DC-DC converter according to one or more embodiments;

FIG. 5 is a circuit diagram exemplary of the DC-DC converter of FIG. 4, with control signals of a first operating mode, suitable for low output voltage;

FIG. 6 is a time diagram exemplary of waveforms of signals in the DC-DC converter of FIG. 5 operated according to the first operating mode;

FIGS. 7A, 7B, 7C and 7D are four circuit diagrams exemplary of the topology of the reactive components of the DC-DC converter of FIG. 5 during four different control phases of the first operating mode;

FIG. 8 is a circuit diagram exemplary of the DC-DC converter of FIG. 4, with control signals of a second operating mode, suitable for nominal output voltage;

FIG. 9 is a time diagram exemplary of waveforms of signals in the DC-DC converter of FIG. 8 operated according to the second operating mode;

FIGS. 10A, 10B, 10C and 10D are four circuit diagrams exemplary of the topology of the reactive components of the DC-DC converter of FIG. 8 during four different control phases of the second operating mode;

FIG. 11 is a circuit diagram exemplary of the DC-DC converter of FIG. 4, with control signals of a third operating mode, suitable for high output voltage;

FIG. 12 is a time diagram exemplary of waveforms of signals in the DC-DC converter of FIG. 11 operated according to the third operating mode; and

FIGS. 13A, 13B and 13C are three circuit diagrams exemplary of the topology of the reactive components of the DC-DC converter of FIG. 11 during three different control phases of the third operating mode.

### DETAILED DESCRIPTION

In the ensuing description, one or more specific details are illustrated, aimed at providing an in-depth understanding of examples of embodiments of this description. The embodiments may be obtained without one or more of the specific details, or with other methods, components, materials, etc. In other cases, known structures, materials, or operations are not illustrated or described in detail so that certain aspects of embodiments will not be obscured.

Reference to “an embodiment” or “one embodiment” in the framework of the present description is intended to indicate that a particular configuration, structure, or characteristic described in relation to the embodiment is included in at least one embodiment. Hence, phrases such as “in an embodiment” or “in one embodiment” that may be present in one or more points of the present description do not necessarily refer to one and the same embodiment. Moreover, particular configurations, structures, or characteristics may be combined in any adequate way in one or more embodiments.

The headings/references used herein are provided merely for convenience and hence do not define the extent of protection or the scope of the embodiments.

Throughout the figures annexed herein, unless the context indicates otherwise, like parts or elements are indicated with like references/numerals and a corresponding description will not be repeated for the sake of brevity.

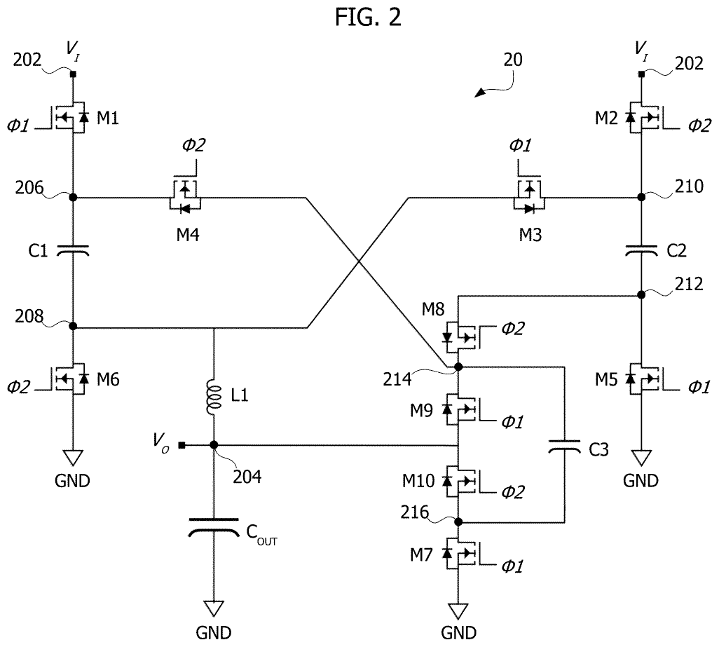

As anticipated, the present description relates to hybrid DC-DC converters that combine switched-capacitor-based and inductor-based topologies. FIG. 2 is a circuit diagram exemplary of a hybrid DC-DC converter 20 according to one or more embodiments, which substantially combines two switched-capacitor converters with a buck converter, so as to create an interleaved topology that provides some improvements over the known hybrid converter structures.

The DC-DC converter 20 has an input terminal 202 configured to receive an input voltage V_{I} (shown twice in FIG. 2 for the sake of ease of illustration) and an output terminal 204 configured to produce an output voltage V₀. An electronic switch M1 is arranged between the input terminal 202 and a node 206. A capacitor C1 is arranged between node 206 and a node 208. An electronic switch M6 is arranged between node 208 and ground GND. An electronic switch M2 is arranged between the input terminal 202 and a node 210. A capacitor C2 is arranged between node 210 and a node 212. An electronic switch M5 is arranged between node 212 and ground GND. An electronic switch M8 is arranged between node 212 and a node 214.

An electronic switch M9 is arranged between node 214 and the output terminal 204. An electronic switch M10 is arranged between the output terminal 204 and a node 216. An electronic switch M7 is arranged between node 216 and ground GND. A capacitor C3 is arranged between node 214 and node 216. An electronic switch M3 is arranged between node 210 and node 208. An electronic switch M4 is arranged between node 206 and node 214. Capacitors C1, C2 and C3 may be discrete components (e.g., external). An inductor L1 (e.g., discrete, external) may be arranged between node 208 and the output terminal 204. Inductor L1 may have an inductance of about 470 nH. An output capacitor C_{OUT} (e.g., discrete, external) may be arranged between the output terminal 204 and ground GND. Switches M1, M3, M5, M7 and M9 are controlled by a first control signal Φ1, and switches M2, M4, M6, M8 and M10 are controlled by a second control signal Φ2. Each one of the switches M1 to M10 is conductive if the respective control signal is asserted (e.g., high, logic ‘1’) and is not conductive if the respective control signal is de-asserted (e.g., low, logic ‘0’). The control signals Φ1 and Φ2 may be produced internally or externally by a control circuit of the DC-DC converter 20. As exemplified in FIG. 2, the electronic switches M1 to M10 may be transistors, in particular (power) MOS transistors, which receive their control signals at their respective control terminals (e.g., gate terminals in the case of MOS transistors). In the examples illustrated herein, the switches M1 to M10 are power n-channel MOS transistors.

In one or more embodiments, the control signals Φ1 and Φ2 of the DC-DC converter 20 are in counter-phase (i.e., when Φ1 is asserted Φ2 is de-asserted, and vice versa- or in other words, Φ1 and Φ2 are complementary), so that the converter 20 can operate with two consecutive control phases during each switching cycle: a first phase F1 during which the switches M1, M3, M5, M7 and M9 are conductive and the switches M2, M4, M6, M8 and M10 are not conductive (i.e., during which Φ1 is asserted Φ2 is de-asserted), and a second phase F2 during which the switches M1, M3, M5, M7 and M9 are not conductive and the switches M2, M4, M6, M8 and M10 are conductive (i.e., during which Φ1 is de-asserted Φ2 is asserted).

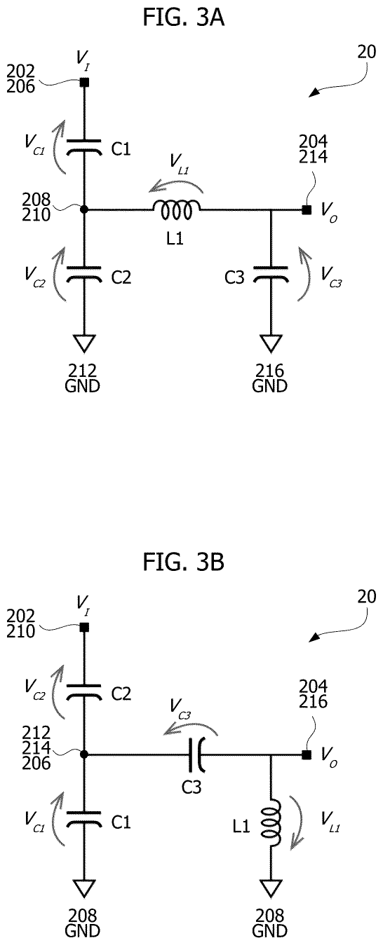

FIG. 3A is a circuit diagram exemplary of the topology of the reactive components of the DC-DC converter 20 during the first control phase F1, while FIG. 3B is a circuit diagram exemplary of the topology of the reactive components of the DC-DC converter 20 during the second control phase F2.

During the first control phase F1, the first terminal of capacitor C1 is coupled to the input terminal 202, the second terminal of capacitor C1 is coupled to the first terminal of capacitor C2 and to the first terminal of inductor L1, the first terminal of capacitor C2 is coupled to the second terminal of capacitor C1 and to the first terminal of inductor L1, the second terminal of capacitor C2 is coupled to ground, the first terminal of capacitor C3 is coupled to the output terminal 204, the second terminal of capacitor C3 is coupled to ground, the first terminal of inductor L1 is coupled to the second terminal of capacitor C1 and to the first terminal of capacitor C2, and the second terminal of inductor L1 is coupled to the output terminal 204.

During the second (last) control phase F2, the first terminal of capacitor C1 is coupled to the second terminal of capacitor C2 and to the first terminal of capacitor C3, the second terminal of capacitor C1 is coupled to ground, the first terminal of capacitor C2 is coupled to the input terminal 202, the second terminal of capacitor C2 is coupled to the first terminal of capacitor C1 and to the first terminal of capacitor C3, the first terminal of capacitor C3 is coupled to the first terminal of capacitor C1 and to the second terminal of capacitor C2, the second terminal of capacitor C3 is coupled to the output terminal 204, the first terminal of inductor L1 is coupled to ground, and the second terminal of inductor L1 is coupled to the output terminal 204.

The (e.g., external) output capacitor C_{OUT} is not shown in FIGS. 3A and 3B for ease of illustration. In FIGS. 3A and 3B, the following voltages are also indicated: voltage V_{C1} across capacitor C1 measured between node 206 and node 208, voltage V_{C2} across capacitor C2 measured between node 210 and node 212, voltage V_{C3} across capacitor C3 measured between node 214 and node 216, and voltage V_{L1} across inductor L1 measured between node 208 and the output terminal 204.

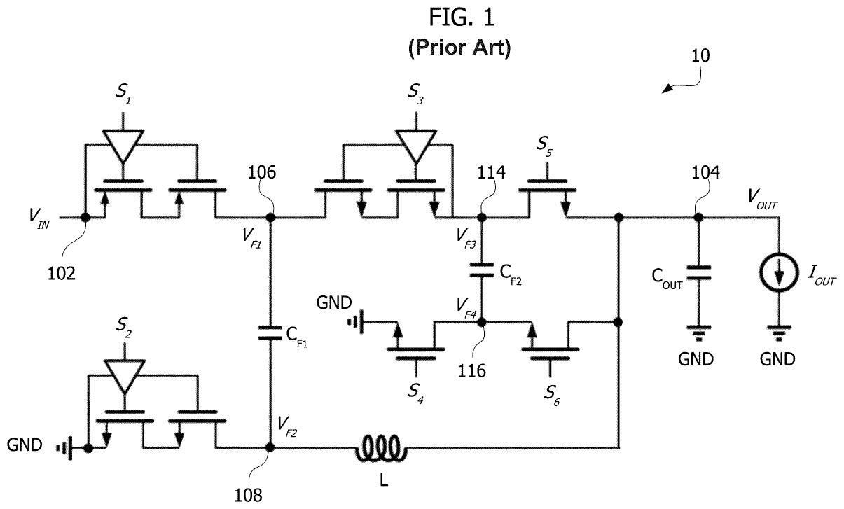

In one or more embodiments as exemplified in FIG. 2 and operating according to the control phases of FIGS. 3A and 3B, there is a respective branch of the DC-DC converter 20 that is active and absorbs current from the input terminal 202 (e.g., from the input supply voltage V_{I}) during each of the control phases F1 and F2. In this way, the input current of the DC-DC converter is quasi-DC, considerably reducing the input rms current and allowing for the reduction of the capacitance value and volume of the input capacitor (e.g., 6.5× reduction of the capacitance value, and 4.63× reduction of the volume compared to the known solution exemplified in FIG. 1). The reshaping of the input current also significantly decreases the electromagnetic interference (EMI) of the converter. Substantially, the filter capacitance C_{F1} of the know solution exemplified in FIG. 1 is split into the two capacitors C1 and C2, halving their current rating and allowing for a significant reduction of the capacitance value and volume of the filter capacitors C1 and C2 (e.g., 2× reduction of the capacitance value, and 2× reduction of the total volume compared to the known solution exemplified in FIG. 1). Even the current rating of the high voltage-rated MOS transistors can be halved. Therefore, targeting the same losses that take place in the high voltage-rated MOS transistors under the same working conditions, the area occupation of the MOS transistors can be scaled by a factor 1.6 compared to the known solution exemplified in FIG. 1. The low voltage-rated MOS transistors, as well as the current rating and voltage rating of capacitor C3 (which corresponds to capacitor C_{F2} of the known solution exemplified in FIG. 1), may remain unchanged compared to the known solution. Scaling the components as discussed above results in improved power density and EMI of the converter, while providing in the same efficiency and implementing a simple 2-phase control strategy similar to the one of the known solution exemplified in FIG. 1.

The input to output relationship of the DC-DC converter 20 can be obtained computing the Kirchhoff voltage laws (K.V.L.) on the capacitors terminals and computing the voltage second balance (V.S.B.) on the inductor L1 during the first and second control phases, according to the following equations:

$${F}_{1} K . V . L . : \{ \begin{matrix}{V}_{I} = {V}_{C 1} + {V}_{C 2} \\ {V}_{O} = {V}_{C 3}\end{matrix}$$

$${F}_{2} K . V . L . : \{ \begin{matrix}{V}_{I} = {V}_{C 2} + {V}_{C 3} + {V}_{O} \\ {V}_{O} = {V}_{C 1} - {V}_{C 3}\end{matrix}$$

$${L}_{1} V . S . B . : D \cdot ( {V}_{C 2} - {V}_{O} ) = ( 1 - D ) \cdot {V}_{O}$$

The output voltage V₀ of the DC-DC converter 20 can be computed according to the following equation:

$${V}_{O} = \frac{{V}_{I} \cdot D}{1 + 2 D}$$

The DC current I_{L,DC} of the inductor L1 can be determined computing the current second balance (C.S.B.) on the converter capacitors, according to the following equation:

$${I}_{L , DC} = \frac{{I}_{LOAD}}{1 + 2 D}$$

Therefore, the interleaved DC-DC converter topology exemplified in FIG. 2 allows to scale down the dimensions of the inductor L1 thanks to its limited voltage range, relative to the input voltage, and to its limited current rating, compared to the load current.

Nevertheless, the interleaved DC-DC converter topology exemplified in FIG. 2 may still suffer from high charge redistribution losses, insofar as the current on the capacitor C3 is not set by any inductive element, as well as the currents of the capacitors C1 and C2 during the second control phase F2.

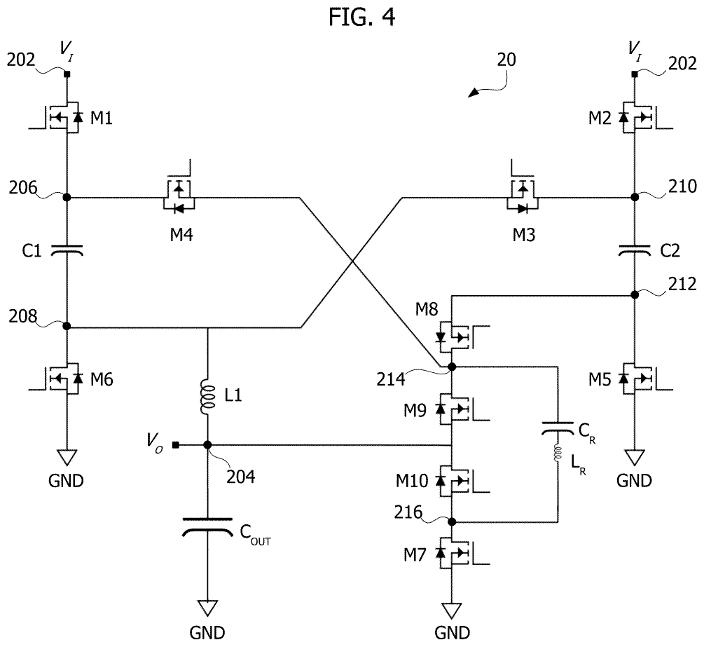

In order to mitigate the issue of the charge redistribution losses in the filter capacitors, one or more embodiments of the DC-DC converter 20 as exemplified in the circuit diagram of FIG. 4 include a resonant tank C_{R}, L_{R} (i.e., a capacitor C_{R} and an inductor L_{R} arranged in series one to the other that operate at resonance) arranged between node 214 and node 216, in the place of the capacitor C3 (or, stated otherwise, a resonant inductor arranged in series to the capacitor C3, now referred to as C_{R}). Inductor L_{R} may have an inductance of about 1 nH. By using a resonant tank C_{R}, L_{R}, the charging/discharging current of capacitor C_{R} has a sinusoidal waveform, lowering significantly its rms value compared to the embodiments exemplified in FIG. 2. The sinusoidal current flowing through capacitor C_{R} has a frequency F_{RES} (corresponding to the resonance frequency of the tank) that can be computed according to the following equation, where L_{RES} is the inductance of the resonant inductor L_{R} and C_{RES} is the capacitance of the resonant capacitor C_{R}:

$${F}_{RES} = \frac{1}{2 π \sqrt{{L}_{RES} \cdot {C}_{RES}}}$$

Using a resonant tank C_{R}, L_{R} allows to implement a Zero Current Switching (ZCS) technique. By properly sizing the resonant frequency F_{RES}, the activation/deactivation of the switches (i.e., turn-on and turn-off of the power MOS transistors) can be synchronized with the time instant in which the sinusoidal current flowing through the resonant tank is equal to zero, thereby decreasing the switching losses. The charging/discharging currents of the filter capacitors C1 and C2, on the other hand, are shaped by the currents of the discrete inductor L1 or the resonant tank, depending on the converter phase. The resonant frequency F_{RES} of the resonant tank can be set to be slightly higher than the converter switching frequency F_{SW}, so as to allow for regulation of the output voltage. In fact, higher output voltage ranges correspond to higher resonant frequencies, since the maximum converter duty-cycle DMAX that allows a sinusoidal current to flow through the resonant tank is given by the following equation, where T_{SW} and T_{RES} are the switching period and resonance period, respectively (i.e., the reciprocal of the switching frequency and resonance frequency):

$${D}_{MAX} = \frac{{T}_{SW} - {T}_{RES} / 2}{{T}_{SW}}$$

The resonant frequency F_{RES} of the resonant tank cannot be indefinitely raised, in order to prevent the rms current of the resonant tank from increasing excessively. Capacitors C1, C2 and C_{R} may be discrete components (e.g., external). The tank inductor L_{R} may be implemented exploiting the parasitic inductance of the VIAs and/or traces of the printed circuit board (PCB), so that the number of discrete components of the resonant DC-DC converter of FIG. 4 remains unchanged with respect to the number of discrete components of the DC-DC converter of FIG. 2.

It will be noted that in FIG. 4 the control signals of switches M1 to M10 are not indicated. This is intentional because, as will be further described in the following, the switches M1 to M10 can be controlled according to different operating modes (and thus using control signals with a different timing) depending on the desired output voltage. In particular, a first operating mode may be suitable for a low output voltage range, a second operating mode may be suitable for a nominal output voltage range, and a third operating mode may be suitable for a high output voltage range.

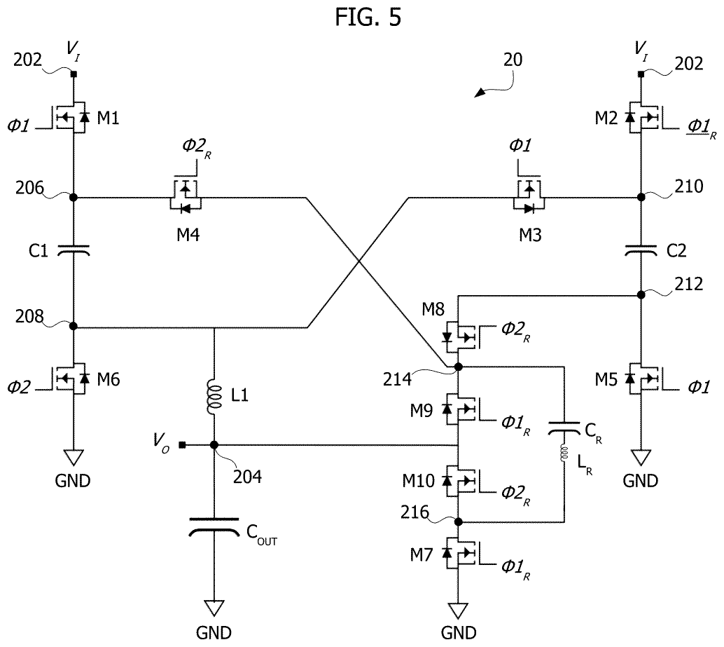

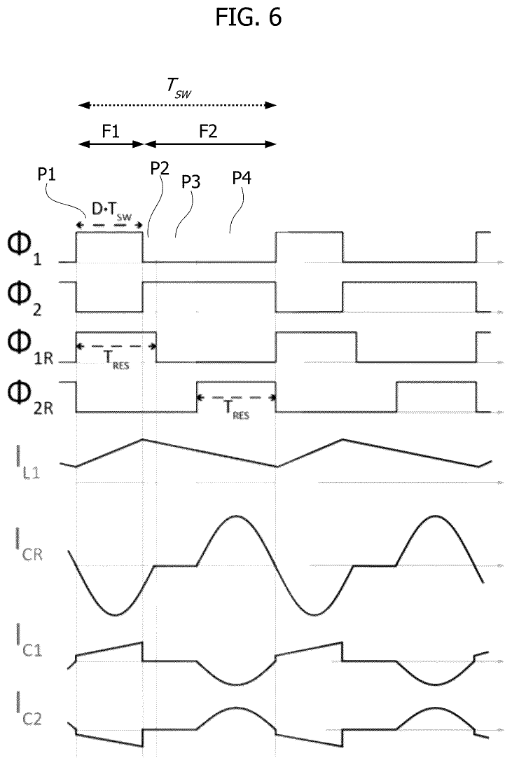

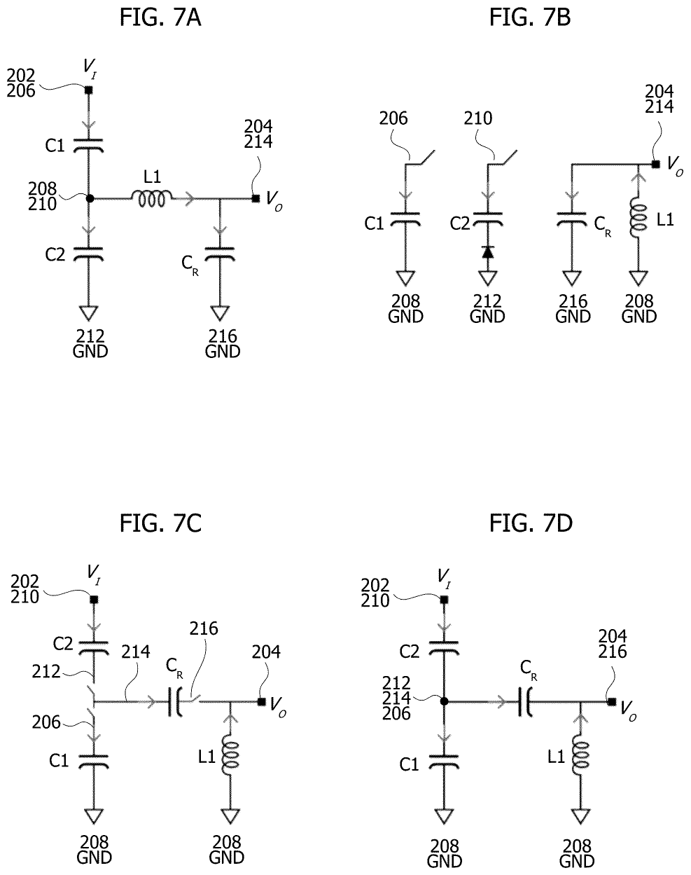

FIG. 5 is a circuit diagram exemplary of the resonant DC-DC converter 20 of FIG. 4, using four control signals Φ1, Φ2, Φ1_{R} and Φ2_{R} in the first operating mode suitable for a low output voltage range (e.g., V₀ lower than 1.1 V). In particular, switch M1 is controlled by signal Φ1, switch M6 is controlled by signal Φ2, switch M2 is controlled by the complement Φ1_{R} of signal Φ1_{R}, switch M5 is controlled by signal Φ1, switch M8 is controlled by signal Φ2_{R}, switch M9 is controlled by signal Φ1_{R}, switch M10 is controlled by signal Φ2_{R}, switch M7 is controlled by signal Φ1_{R}, switch M3 is controlled by signal Φ1, and switch M4 is controlled by signal Φ2_{R}. FIG. 6 is a time diagram exemplary of the waveforms of signals in the DC-DC converter of FIG. 5, including the four control signals Φ1, 2, Φ1_{R} and Φ2_{R} that are set so as to operate the DC-DC converter with four consecutive phases P1, P2, P3, P4, and the currents I_{L1}, I_{CR}, I_{C1} and I_{C2} flowing through components L1, C_{R}, C1 and C2, respectively. FIGS. 7A to 7D are circuit diagrams exemplary of the topology of the reactive components of the DC-DC converter 20 during each of the four control phases P1, P2, P3 and P4 of the first operating mode.

As exemplified in FIG. 6, all the control signals have the same period T_{SW} (i.e., the switching period of the converter). Signals Φ1 are Φ2 substantially the same as in the two-phase control method disclosed with reference to FIGS. 2, 3A and 3B. Therefore, signal Φ1 is asserted at the start of a switching cycle, remains asserted for a time interval D·T_{SW}, and then stays de-asserted for a time interval (1-D)·T_{SW}. Signal Φ2 is the complement of signal Φ1. Signal Φ1_{R} is a replica of signal Φ1 having delayed falling edges, i.e., it gets asserted at the same time as signal Φ1 but remains asserted for a time interval T_{RES} that is (slightly) longer than D·T_{SW} and shorter than (1-D). T_{SW}. Signal Φ2_{R} is a replica of signal Φ2 having delayed rising edges, i.e., it gets de-asserted at the same time as signal Φ2 and is asserted for the time interval T_{RES}. Therefore, in the first operating mode, the four phases are as follows.

In the first control phase P1 (see FIG. 7A), signals Φ1 and Φ1_{R} are asserted, while signals Φ2 and Φ2_{R} are de-asserted. Therefore, the switches M1, M3, M5, M7 and M9 are conductive and the switches M2, M4, M6, M8 and M10 are not conductive. Therefore, during the first control phase P1, the first terminal of capacitor C1 is coupled to the input terminal 202, the second terminal of capacitor C1 is coupled to the first terminal of capacitor C2 and to the first terminal of inductor L1, the first terminal of capacitor C2 is coupled to the second terminal of capacitor C1 and to the first terminal of inductor L1, the second terminal of capacitor C2 is coupled to ground, the first terminal of capacitor C_{R} is coupled to the output terminal 204, the second terminal of capacitor C_{R} is coupled to ground, the first terminal of inductor L1 is coupled to the second terminal of capacitor C1 and to the first terminal of capacitor C2, and the second terminal of inductor L1 is coupled to the output terminal 204. Substantially, phase P1 (FIG. 7A) is similar to phase F1 (FIG. 3A), with the difference that a resonant tank C_{R}, L_{R} is provided in the place of capacitor C3.

In the second control phase P2 (see FIG. 7B), signals Φ2 and Φ1_{R} are asserted, while signals Φ1 and Φ2_{R} are de-asserted. Therefore, the switches M6, M7 and M9 are conductive and the switches M1, M2, M3, M4, M5, M8 and M10 are not conductive. Therefore, during the second control phase P2, the first terminal of capacitor C1 is floating, the second terminal of capacitor C1 is coupled to ground, the first terminal of capacitor C2 is floating, the second terminal of capacitor C2 is floating (but coupled to ground via the parasitic diode of transistor M5), the first terminal of capacitor C_{R} is coupled to the output terminal 204, the second terminal of capacitor C_{R} is coupled to ground, the first terminal of inductor L1 is coupled to ground, and the second terminal of inductor L1 is coupled to the output terminal 204. Therefore, a first resonant phase extends through the control phases P1 and P2, lasting longer than the first control phase F1 of the non-resonant embodiment of FIG. 2.

In the third control phase P3 (see FIG. 7C), signal Φ2 is asserted, while signals Φ1, Φ1_{R} and Φ2_{R} are de-asserted. Therefore, the switches M2 and M6 are conductive and the switches M1, M3, M4, M5, M7, M8, M9 and M10 are not conductive. Therefore, during the third control phase P3, the first terminal of capacitor C1 is floating, the second terminal of capacitor C1 is coupled to ground, the first terminal of capacitor C2 is coupled to the input terminal 202, the second terminal of capacitor C2 is floating, the first terminal of capacitor C_{R} is floating, the second terminal of capacitor C_{R} is floating, the first terminal of inductor L1 is coupled to ground, and the second terminal of inductor L1 is coupled to the output terminal 204.

In the fourth (last) control phase P4 (see FIG. 7D), signals Φ2 and Φ2_{R} are asserted, while signals Φ1 and Φ1_{R} are de-asserted. Therefore, the switches M2, M4, M6, M8 and M10 are conductive and the switches M1, M3, M5, M7 and M9 are not conductive. Therefore, during the fourth control phase P4, the first terminal of capacitor C1 is coupled to the second terminal of capacitor C2 and to the first terminal of capacitor C_{R}, the second terminal of capacitor C1 is coupled to ground, the first terminal of capacitor C2 is coupled to the input terminal 202, the second terminal of capacitor C2 is coupled to the first terminal of capacitor C1 and to the first terminal of capacitor C_{R}, the first terminal of capacitor C_{R} is coupled to the first terminal of capacitor C1 and to the second terminal of capacitor C2, the second terminal of capacitor C_{R} is coupled to the output terminal 204, the first terminal of inductor L1 is coupled to ground, and the second terminal of inductor L1 is coupled to the output terminal 204. Substantially, phase P4 (FIG. 7D) is similar to phase F2 (FIG. 3B), with the difference that a resonant tank C_{R}, L_{R} is provided in the place of capacitor C3.

When functioning in the first operating mode of FIGS. 5, 6 and 7A to 7D, the DC-DC converter 20 has the same input-to-output relationship shown previously, which can be verified by computing K.V.L. on the capacitors and V.S.B. on the inductor, i.e.:

$${V}_{O} = \frac{{V}_{I} \cdot D}{1 + 2 D}$$

In the first control phase P1, the DC-DC converter is configured as in the first control phase F1 of the non-resonant embodiment exemplified in FIGS. 2, 3A and 3B. During the second control phase P2 (which “extends” the resonant phase beyond the end of the phase F1), since the tank is resonating by itself, a sinusoidal current flows through the tank independently from the duration of the phase F1. Therefore, when the control signal Φ1 gets de-asserted, the two currents of the filter capacitors C1 and C2 can be forced to zero while the inductor L1 is shorted to ground, resulting in the second converter configuration. In the phase P2 the capacitor C2 is coupled to ground through the parasitic diode of the transistor M5 (e.g., power MOSFET). When the first resonant phase P1+P2 ends, also the tank current is forced to zero (third configuration, control phase P3). Then, a second resonant phase takes place during the last control phase P4, and a sinusoidal current once again flows through the tank and through the filter capacitors C1 and C2. Thus, the charging/discharging currents I_{C1}, I_{C2} of the filter capacitors C1, C2 are either shaped by the inductor L1 or by the resonant tank C_{R}, L_{R}.

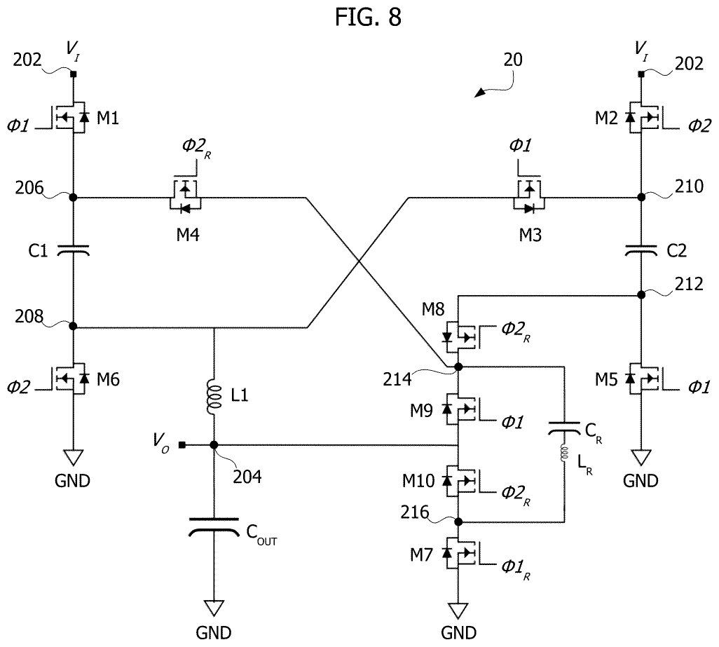

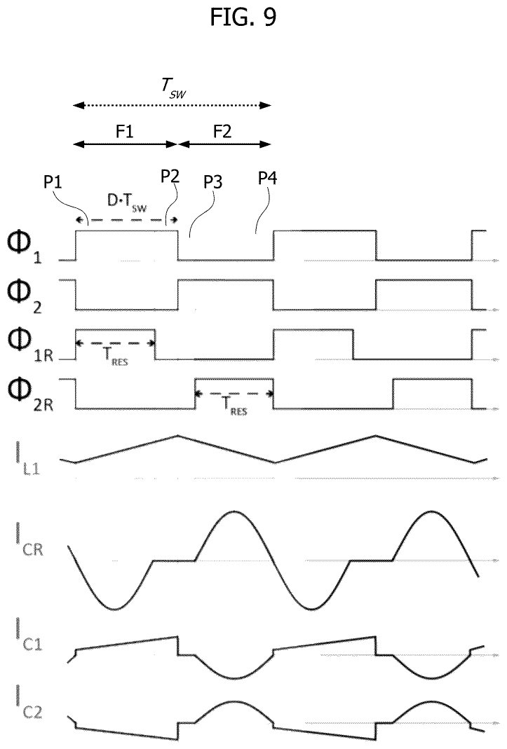

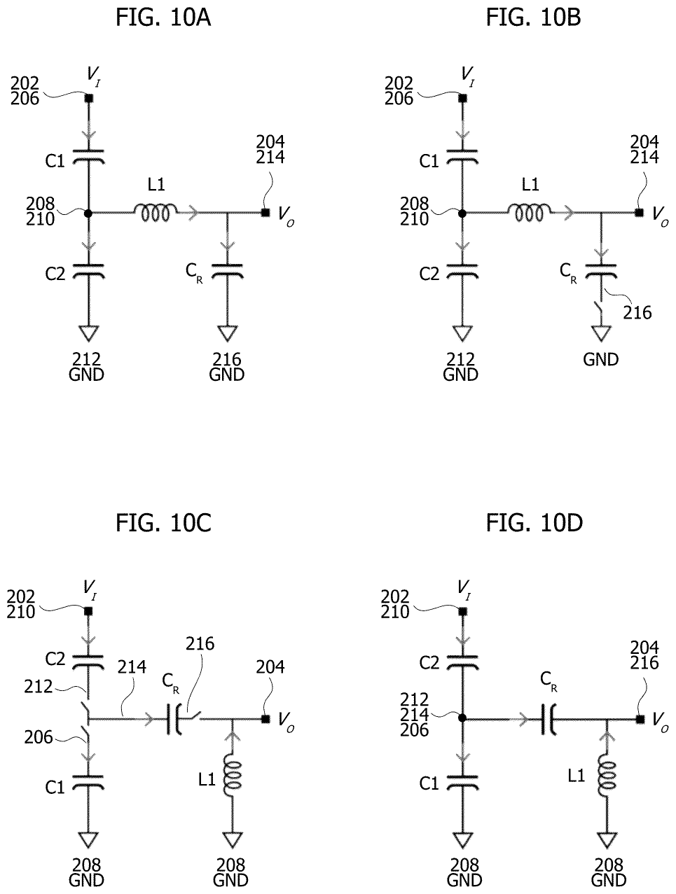

FIG. 8 is a circuit diagram exemplary of the resonant DC-DC converter 20 of FIG. 4, using four control signals Φ1, Φ2, Φ1_{R} and Φ2_{R} in the second operating mode suitable for a nominal output voltage range (e.g., V₀ between 1.1 V and 1.35 V). Compared to FIG. 5, switch M2 is now controlled by signal Φ2 and switch M9 is now controlled by signal Φ1. In particular, switch M1 is controlled by signal Φ1, switch M6 is controlled by signal Φ2, switch M2 is controlled signal Φ2, switch M5 is controlled by signal Φ1, switch M8 is controlled by signal Φ2_{R}, switch M9 is controlled by signal Φ1, switch M10 is controlled by signal Φ2_{R}, switch M7 is controlled by signal Φ_{R}, switch M3 is controlled by signal Φ1, and switch M4 is controlled by signal Φ2_{R}. FIG. 9 is a time diagram exemplary of the waveforms of signals in the DC-DC converter of FIG. 8, including the four control signals Φ1, Φ2, Φ1_{R} and Φ2_{R} that are set so as to operate the DC-DC converter with four consecutive phases P1, P2, P3, P4, and the currents I_{L1}, I_{CR}, I_{C1} and I_{C2} flowing through components L1, C_{R}, C1 and C2, respectively. FIGS. 10A to 10D are circuit diagrams exemplary of the topology of the reactive components of the DC-DC converter 20 during each of the four control phases P1, P2, P3 and P4 of the second operating mode.

As exemplified in FIG. 9, all the control signals have the same period T_{SW} (i.e., the switching period of the converter). Signals Φ1 are Φ2 substantially the same as in the two-phase control method disclosed with reference to FIGS. 2, 3A and 3B. Therefore, signal Φ1 is asserted at the start of a switching cycle, remains asserted for a time interval D·T_{SW}, and then stays de-asserted for a time interval (1-D)·T_{SW}. Signal Φ2 is the complement of signal Φ1. Signal Φ1_{R} is a replica of signal Φ1 having anticipated falling edges, i.e., it gets asserted at the same time as signal Φ1 but remains asserted for a time interval T_{RES} that is (slightly) shorter than D·T_{SW} and shorter than (1-D)·T_{SW}. Signal Φ2_{R} is a replica of signal Φ2 having delayed rising edges, i.e., it gets de-asserted at the same time as signal Φ2 and is asserted for the time interval T_{RES}. Therefore, in the second operating mode, the four phases are as follows.

In the first control phase P1 (see FIG. 10A), signals Φ1 and Φ1_{R} are asserted, while signals Φ2 and Φ2_{R} are de-asserted. Therefore, the switches M1, M3, M5, M7 and M9 are conductive and the switches M2, M4, M6, M8 and M10 are not conductive. Therefore, the first control phase P1 of the second operating mode (see FIG. 10A) is equal to the first control phase P1 of the first operating mode (see FIG. 7A).

In the second control phase P2 (see FIG. 10B), signal Φ1 is asserted, while signals Φ2, Φ1_{R} and Φ2_{R} are de-asserted. Therefore, the switches M1, M3, M5 and M9 are conductive and the switches M2, M4, M6, M7, M8 and M10 are not conductive. Therefore, during the second control phase P2, the first terminal of capacitor C1 is coupled to the input terminal 202, the second terminal of capacitor C1 is coupled to the first terminal of capacitor C2 and to the first terminal of inductor L1, the first terminal of capacitor C2 is coupled to the second terminal of capacitor C1 and to the first terminal of inductor L1, the second terminal of capacitor C2 is coupled to ground, the first terminal of capacitor C_{R} is coupled to the output terminal 204, the second terminal of capacitor C_{R} is floating, the first terminal of inductor L1 is coupled to the second terminal of capacitor C1 and to the first terminal of capacitor C2, and the second terminal of inductor L1 is coupled to the output terminal 204. Therefore, a first resonant phase extends only through the control phase P1, lasting shorter than the first control phase F1 of the non-resonant embodiment of FIG. 2.

In the third control phase P3 (see FIG. 10C), signal Φ2 is asserted, while signals Φ1, Φ1_{R} and Φ2_{R} are de-asserted. Therefore, the switches M2 and M6 are conductive and the switches M1, M3, M4, M5, M7, M8, M9 and M10 are not conductive. Therefore, the third control phase P3 of the second operating mode (see FIG. 10C) is equal to the third control phase P3 of the first operating mode (see FIG. 7C).

In the fourth (last) control phase P4 (see FIG. 10D), signals Φ2 and Φ2_{R} are asserted, while signals Φ1 and Φ1_{R} are de-asserted. Therefore, the switches M2, M4, M6, M8 and M10 are conductive and the switches M1, M3, M5, M7 and M9 are not conductive. Therefore, the fourth control phase P4 of the second operating mode (see FIG. 10D) is equal to the fourth control phase P4 of the first operating mode (see FIG. 7D).

When functioning in the second operating mode of FIGS. 8, 9 and 10A to 10D (i.e., at nominal working conditions), the first resonance phase corresponds to the first control phase P1, and lasts less that the assertion time of signal Φ1 (i.e., less than the duration of the first control phase of the non-resonant embodiment of FIG. 2). When signal Φ1_{R} gets de-asserted, the current flowing through the resonant tank is forced to zero throughout the control phase P2. Then, when the control phase P2 ends, the inductor L1 is shorted to ground and the currents of the filter capacitors C1, C2 are forced to zero. The sinusoidal current of the resonant tank is then pushed through the filter capacitors C1, C2 during the control phase P4. The input-to-output transfer function computed for the non-resonant embodiment of FIG. 2 still holds for the resonant embodiment of FIG. 8, as well as the value of the DC current of inductor L1.

When it comes to high output voltage ranges (e.g., V₀ higher than 1.35 V), it is not possible to indefinitely increase the duration D·T_{SW} of the assertion time of signal Φ1 while keeping constant the assertion time T_{RES} of signal Φ2_{R}, since this would lead to an overlap between the assertion of signal Φ1 and the assertion of signal Φ2_{R}, causing a violation of the Kirchoff voltage law on the filter capacitors. In order to overcome this limitation and maintain the same input-to-output relationship previously discussed, the second resonance phase (i.e., the control phase P4, starting with the assertion of signal Φ2_{R}) can be delayed until when the signal Φ1 gets de-asserted.

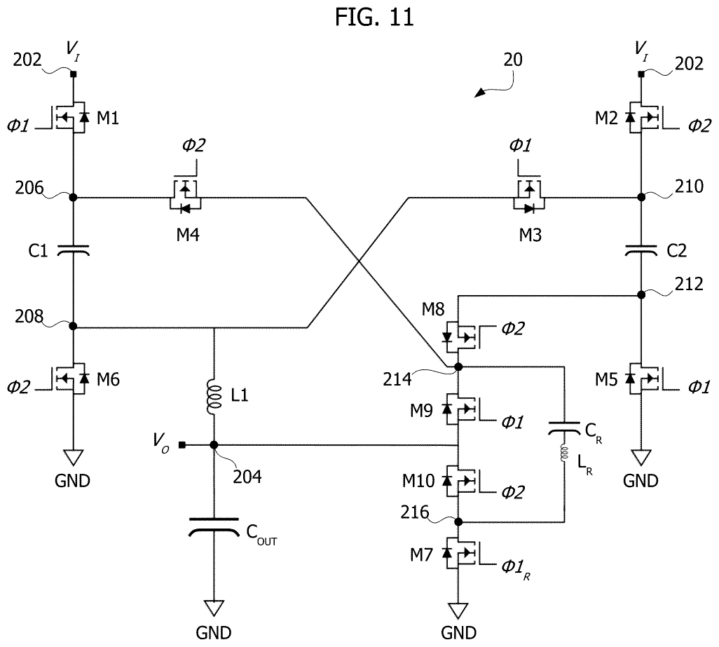

FIG. 11 is a circuit diagram exemplary of the resonant DC-DC converter 20 of FIG. 4, using three control signals Φ1, Φ2 and Φ1_{R} in the third operating mode suitable for a high output voltage range (e.g., V₀ higher than 1.35 V). Compared to FIG. 8, switch M4 is now controlled by signal Φ2, switch M8 is now controlled by signal Φ2, and switch M10 is now controlled by signal Φ2. In particular, switch M1 is controlled by signal Φ1, switch M6 is controlled by signal Φ2, switch M2 is controlled signal Φ2, switch M5 is controlled by signal Φ1, switch M8 is controlled by signal Φ2, switch M9 is controlled by signal Φ1, switch M10 is controlled by signal Φ2, switch M7 is controlled by signal Φ1_{R}, switch M3 is controlled by signal Φ1, and switch M4 is controlled by signal Φ2.

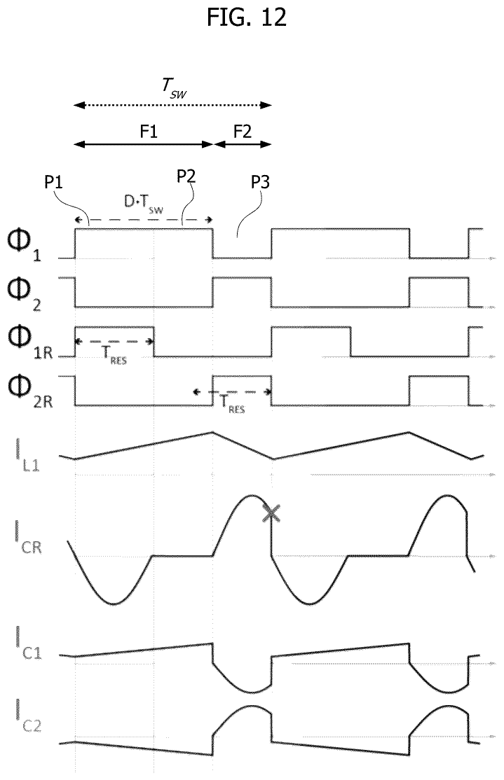

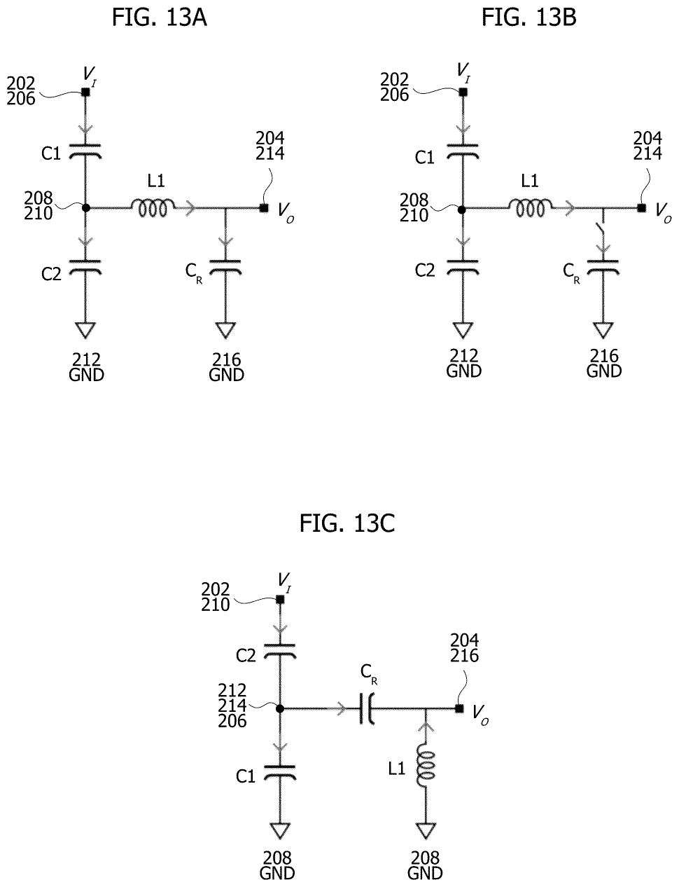

FIG. 12 is a time diagram exemplary of the waveforms of signals in the DC-DC converter of FIG. 11, including the four control signals Φ1, Φ2, Φ1_{R} and Φ2_{R} (with signal Φ2_{R} being equal to signal Φ2) that are set so as to operate the DC-DC converter with three consecutive phases P1, P2, P4, and the currents I_{L1}, I_{CR}, I_{C1} and I_{C2} flowing through components L1, C_{R}, C1 and C2, respectively. FIGS. 13A to 13C are circuit diagrams exemplary of the topology of the reactive components of the DC-DC converter 20 during each of the three control phases P1, P2 and P4 of the third operating mode.

As exemplified in FIG. 12, all the control signals have the same period T_{SW} (i.e., the switching period of the converter). Signals P1 are Φ2 substantially the same as in the two-phase control method disclosed with reference to FIGS. 2, 3A and 3B. Therefore, signal Φ1 is asserted at the start of a switching cycle, remains asserted for a time interval D. T_{SW}, and then stays de-asserted for a time interval (1-D)·T_{SW}. Signal Φ2 is the complement of signal Φ1. Signal Φ1_{R} is a replica of signal Φ1 having anticipated falling edges, i.e., it gets asserted at the same time as signal Φ1 but remains asserted for a time interval T_{RES} that is shorter than D·T_{SW} and longer than (1-D)·T_{SW}. Therefore, in the third operating mode, the three phases are as follows.

In the first control phase P1 (see FIG. 13A), signals Φ1 and Φ1_{R} are asserted, while signal Φ2 is de-asserted. Therefore, the switches M1, M3, M5, M7 and M9 are conductive and the switches M2, M4, M6, M8 and M10 are not conductive. Therefore, the first control phase P1 of the third operating mode (see FIG. 13A) is equal to the first control phase P1 of the first and second operating modes (see FIGS. 7A and 10A, respectively).

In the second control phase P2 (see FIG. 10B), signal Φ1 is asserted, while signals Φ2 and Φ1_{R} are de-asserted. Therefore, the switches M1, M3, M5 and M9 are conductive and the switches M2, M4, M6, M7, M8 and M10 are not conductive. Therefore, the second control phase P2 of the third operating mode (see FIG. 13B) is equal to the second control phase P2 of the second operating mode (see FIG. 10B). Therefore, a first resonant phase extends only through the control phase P1, lasting shorter than the first control phase F1 of the non-resonant embodiment of FIG. 2.

In the third (last) control phase P4 (see FIG. 13C), signal Φ2 is asserted, while signals Φ1 and Φ1_{R} are de-asserted. Therefore, the switches M2, M4, M6, M8 and M10 are conductive and the switches M1, M3, M5, M7 and M9 are not conductive. Therefore, the third control phase P4 of the third operating mode (see FIG. 13C) is equal to the fourth control phase P4 of the first and second operating modes (see FIGS. 7D and 10D, respectively).

When functioning in the third operating mode of FIGS. 11, 12 and 13A to 13C, the first resonance phase corresponds to the first control phase P1, and lasts less than the assertion time of signal P1 (i.e., less than the duration of the first control phase of the non-resonant embodiment of FIG. 2), while the second resonance phase corresponds to the third control phase P4, and lasts less than the resonance period T_{RES}. As a result, change of the control phase of the converter happens with a non-null tank current I_{CR} (see FIG. 12). Nevertheless, this is not a steady-state condition of the converter, but a working regime that can be encountered during line/load transients.

One or more embodiments may thus provide one or more of the following advantages: quasi-DC input current, thanks to the interleaved topology; halved current carried by the high voltage-rated MOS transistors, thanks to the interleaved topology; possibility to downsize the inductor L1, insofar as the DC current through inductor L1 corresponds to half of the load current; and regulation of the output voltage via simple duty-cycle modulation, thanks to the placement of inductor L1 not in series to the load.

Without prejudice to the underlying principles, the details and embodiments may vary, even significantly, with respect to what has been described by way of example only, without departing from the extent of protection.

The claims are an integral part of the technical teaching provided herein in respect of the embodiments.

The extent of protection is determined by the annexed claims.

1. A DC-DC converter, comprising:
an input terminal configured to receive an input voltage;
an output terminal configured to produce an output voltage;
a first capacitor coupled between a first node and a second node;
a second capacitor coupled between a third node and a fourth node;
a third capacitor coupled between a fifth node and a sixth node;
wherein said second node and said output terminal are configured for coupling to the first terminal and the second terminal, respectively, of an inductor;
switching circuitry controllable to:
selectively couple said first node to one or more of said input terminal and said fifth node;
selectively couple said second node to one or more of said third node and ground;
selectively couple said third node to one or more of said input terminal and said second node;
selectively couple said fourth node to one or more of said fifth node and ground;
selectively couple said fifth node to one or more of said first node, said fourth node and said output terminal; and
selectively couple said sixth node to one or more of said output terminal and ground; and
a control circuit configured to produce one or more control signals for said switching circuitry;
wherein the control circuit controls the switching circuitry during a switching cycle of the DC-DC converter in at least:
a first phase during which the first node is coupled to the input terminal, the second node and the third node are coupled to each other, the fourth node is coupled to ground, the fifth node is coupled to the output terminal, and the sixth node is coupled to ground; and
a last phase during which the first node and the fourth node and the fifth node are coupled to each other, the second node is coupled to ground, the third node is coupled to the input terminal, and the sixth node is coupled to the output terminal.

2. The DC-DC converter of claim 1, further comprising a resonant inductor connected in series with said third capacitor between said fifth node and said sixth node.

3. The DC-DC converter of claim 2, wherein the control circuit further controls the switching circuitry during the switching cycle of the DC-DC converter in at least:
an intermediate phase following said first phase and before the last phase during which the first node is floating, the second node is coupled to ground, the third node is floating, the fourth node is coupled to ground, the fifth node is coupled to the output terminal, and the sixth node is coupled to ground; and
a further intermediate phase following said intermediate phase and before the last phase during which the first node is floating, the second node is coupled to ground, the third node is coupled to the input terminal, the fourth node is floating, the fifth node is floating, and the sixth node is floating.

4. The DC-DC converter of claim 2, wherein the control circuit further controls the switching circuitry during the switching cycle of the DC-DC converter in at least:
an intermediate phase following said first phase and before the last phase during which the first node is coupled to the input terminal, the second node and the third node are coupled to each other, the fourth node is coupled to ground, the fifth node is coupled to the output terminal, and the sixth node is floating; and
a further intermediate phase following said intermediate phase and before the last phase during which the first node is floating, the second node is coupled to ground, the third node is coupled to the input terminal, the fourth node is floating, the fifth node is floating, and the sixth node is floating.

5. The DC-DC converter of claim 2, wherein the control circuit further controls the switching circuitry during the switching cycle of the DC-DC converter in at least:
an intermediate phase following said first phase and before the last phase during which the first node is coupled to the input terminal, the second node and the third node are coupled to each other, the fourth node is coupled to ground, the fifth node is coupled to the output terminal, and the sixth node is floating.

6. The DC-DC converter of claim 1, wherein said resonant inductor has an inductance of about 1 nH.

7. The DC-DC converter of claim 1, wherein said resonant inductor is implemented by parasitic inductance of vias and/or metal traces.

8. The DC-DC converter of claim 1, wherein said switching circuitry includes transistors.

9. The DC-DC converter of claim 1, wherein the transistors are n-channel metal-oxide-semiconductor transistors.

10. The DC-DC converter of claim 1, wherein:
the first capacitor is directly connected between the first node and the second node;
the second capacitor is directly connected between the third node and the fourth node;
the third capacitor is directly connected between the fifth node and the sixth node;
the first terminal of the inductor is directly connected to said second node; and
the second terminal of the inductor is directly connected to the output terminal.

11. A method of operating the DC-DC converter of claim 1, comprising:
coupling the first terminal and the second terminal of an inductor to said second node of the DC-DC converter and said output terminal of the DC-DC converter, respectively;
receiving the input voltage at said input terminal;
producing said one or more control signals for said switching circuitry so that, during the switching cycle of the DC-DC converter, the switching circuitry is controlled in at least:
the first phase during which the first node is coupled to the input terminal, the second node and the third node are coupled to each other, the fourth node is coupled to ground, the fifth node is coupled to the output terminal, and the sixth node is coupled to ground; and
the last phase during which the first node and the fourth node and the fifth node are coupled to each other, the second node is coupled to ground, the third node is coupled to the input terminal, and the sixth node is coupled to the output terminal;
to thereby produce an output voltage at said output terminal.
